(19) United States
(12) Patent Application Publication
(10) Pub. No.: US 2012/0150824 A1
(43) Pub. Date: Jun. 14, 2012

(54) Processing System of Data De-Duplication

(75) Inventors: Ming Sheng Zhu, Tianjin (CN); Chih Feng Chen, Taipei (TW)

(73) Assignee: INVENTEC CORPORATION, Taipei (TW)

(21) Appl. No.: 12/965,338

(22) Filed: Dec. 10, 2010

(51) Int. Cl. G06F 17/30

(52) U.S. Cl. 707/692; 707/E17.005; 707/E17.033

(57) ABSTRACT

A processing system of data de-duplication includes a client and a server. A characteristic value of each data block is compared with characteristic values stored in the client. If the same characteristic value exists in the client, the data block corresponding to the compared characteristic value is deleted. A server data management module is connected to a client data management module through a network. If the characteristic value does not exist in the server, a corresponding data block is obtained from the client, and the new data block and the characteristic value are stored in the server. A file management module records a storage address of the data blocks in the server into an index file. In this way, the server is not required to perform all data de-duplication processes of the clients, thus reducing the occupation of bandwidth and improving the processing efficiency of the server.

### BACKGROUND OF THE INVENTION

1. Field of Invention

The present invention relates to a system for storing files, and more particularly to a processing system of data de-duplication.

2. Related Art

Data de-duplication is a data reduction technology, which is usually used in a disk-based backup system with the main purpose of reducing the storage capacity used in the storage system. The operation mode thereof is to search for duplicate and variable sized data blocks at different locations in different files during a certain time period. The duplicate data blocks are replaced by indicators. Since the storage system is always full of a large amount of redundant data, in order to solve the problem and save more space, the de-duplication technology naturally becomes the focus of attention. The de-duplication technology enables the stored data to reduce to 1/20 of the original, thus providing more backup space, so that the backup data in the storage system can be maintained for a longer time, and a large amount of bandwidth required during offline storage is saved. Referring to FIG. 1, it is a schematic view illustrating access of data de-duplication in the conventional art.

Since data to be stored is stored in a server, a client is required to transmit the data to the server in real time, and then, the server performs a data de-duplication process on the data. In the case of an architecture having multiple clients, the server is inevitably under a high-pressure load.

### SUMMARY OF THE INVENTION

Accordingly, the present invention is a processing system of data de-duplication, which performs a data de-duplication process on an input file through a server and a client.

To achieve the above objective, the present invention provides a processing system of data de-duplication, which comprises a client data management module and a server data management module. The client data management module is disposed in each client, and receives the input file. The client data management module further comprises a data chunking module, a fingerprinting module, and a characteristic value search module. The data chunking module is used for performing a data segmentation procedure on the input file, and generating at least one data block. The fingerprinting module performs a characteristic processing procedure on the data blocks, and generates corresponding characteristic values. The characteristic value of each data block is compared with characteristic values stored in the client. If the same characteristic value exists in the client, the data block corresponding to the compared characteristic value is deleted; and if the same characteristic value does not exist in the client, the client sends a query request to the server. The server data management module is connected to the client data management module through a network, and further comprises a characteristic storage module, a file management module, and a data storage module. The characteristic storage module judges whether the characteristic value is recorded in the server according to the query request, and if the characteristic value does not exist in the server, obtains a corresponding data block from the client and stores the new data block and the characteristic value in the server. The file management module is used for recording a storage address of the data blocks of each input file in the server into an index file. The data storage module is used for storing a meta-data of the data blocks and the input file.

In the present invention, the storage of all data blocks, the description of the meta-data, and the storage and management of a characteristic value are all implemented in the server, while operations such as the data segmentation of an input file and the calculation of the characteristic value are implemented by the client. Then, the information is exchanged between the server and the client through the network. When the client processes data, the calculated characteristic value is sent to the server first, if the data exists, only location reference information of the data block needs to be updated and the data block itself does not need to be transmitted over the network, and if the data does not exist, the data is sent to the server. In this way, the storage space of the server is saved, and the requirements for network bandwidth are reduced.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating access of data de-duplication in the conventional art;

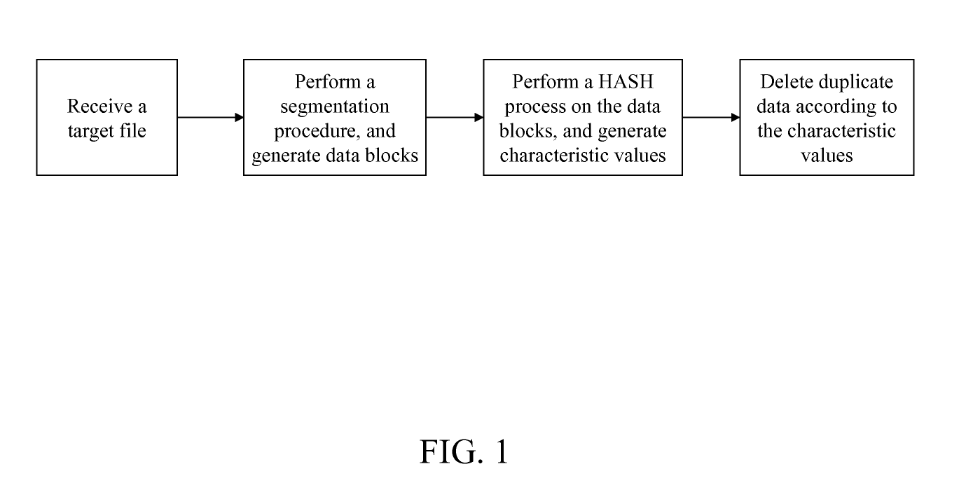

FIG. 2 is a schematic architectural view of the present invention; and

FIG. 3 is an operation flow chart of the present invention.

### DETAILED DESCRIPTION OF THE INVENTION

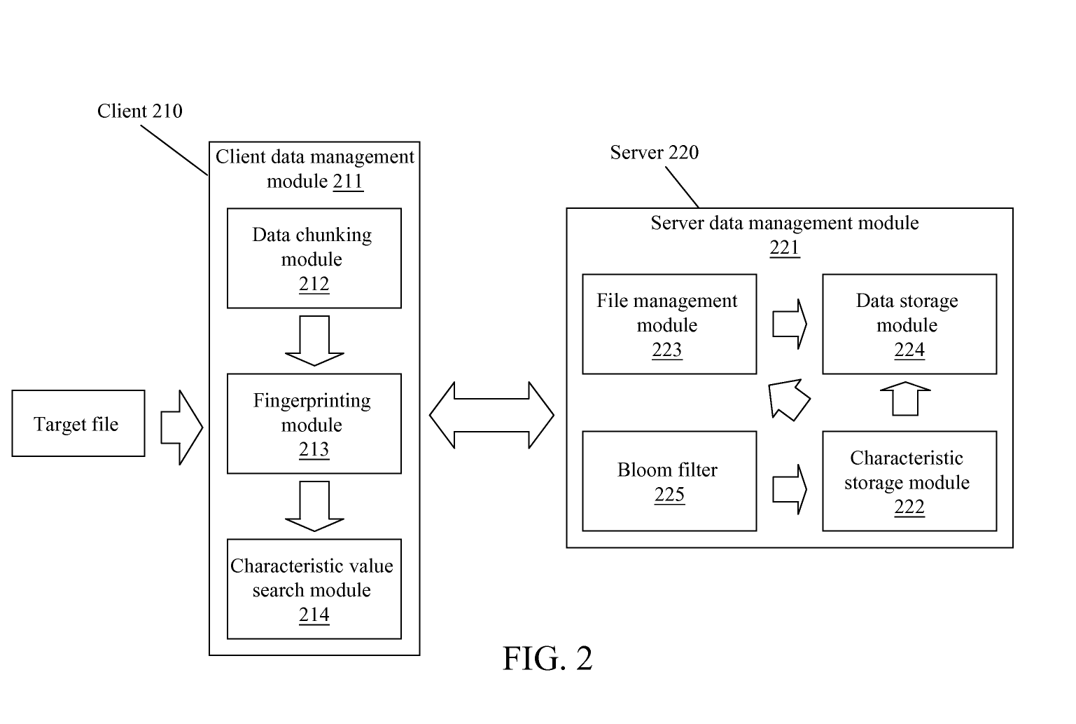

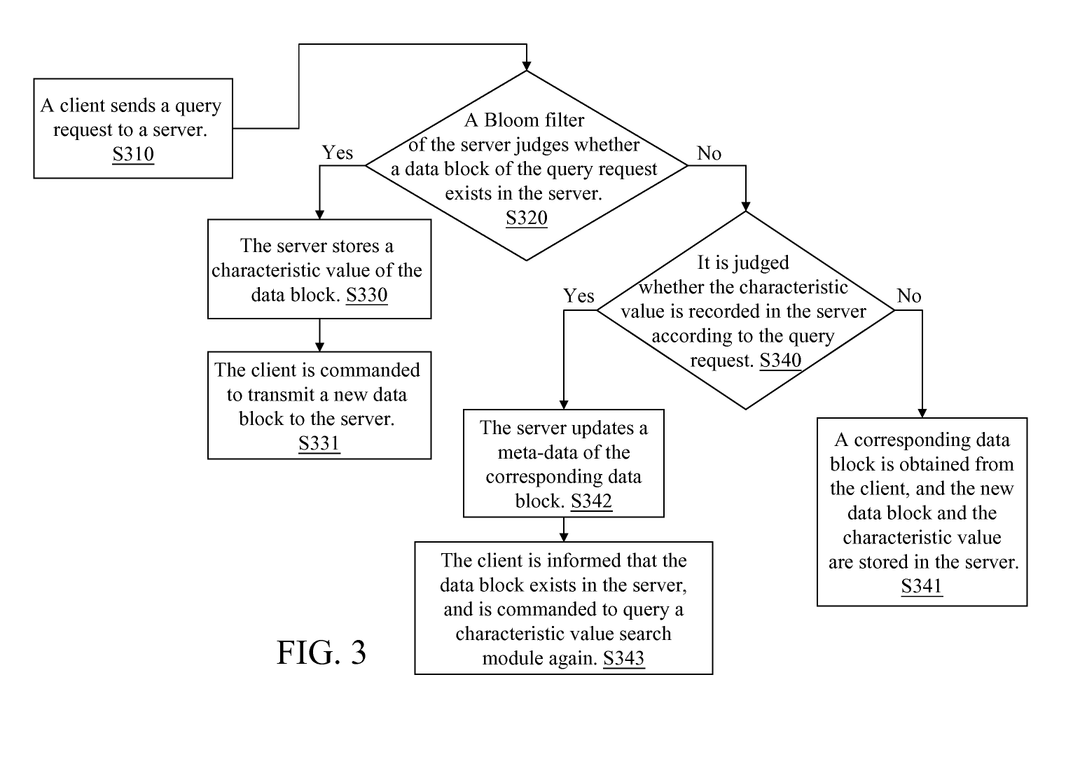

The present invention is applied to a computer having a data de-duplication procedure, such as a personal computer, a notebook computer, or a server, or is applied to a client-server architecture. A processing system of data de-duplication comprises at least one client 210 and a server 220. Referring to FIGS. 2 and 3, they are respectively a schematic architectural view and an operation flow chart of the present invention. The client 210 may be connected to the server through an Internet or an intranet. In order to further describe the operation of each module of the present invention, the operation is illustrated with reference to FIG. 3. The data de-duplication process of the present invention includes the following steps.

In S310, a client sends a query request to a server.

In S320, a Bloom filter of the server judges whether a data block of the query request exists in the server.

In S330, if the data block to be queried exists in the server, the server stores a characteristic value of the data block.

In S331, the client is commanded to transmit a new data block to the server.

In S340, if the data block to be queried does not exist in the server, it is judged whether the characteristic value is recorded in the server according to the query request.

In S341, if the characteristic value does not exist in the server, a corresponding data block is obtained from the client, and the new data block and the characteristic value are stored in the server.

In S342, if the characteristic value exists in the server, the server updates a meta-data of the corresponding data block.

In S343, the client is informed that the data block exists in the server, and is commanded to query a characteristic value search module again.

Each client 210 has a client data management module 211, and the client data management module 211 receives an input file and runs a part of the data de-duplication procedure (the specific operation will be described in detail later). The client data management module 211 further comprises a data chunking module 212, a fingerprinting module 213, and a characteristic value search module 214. The server 220 comprises a server data management module 221, and the server data management module 221 is connected to the client data management module 211 through a network. The server data management module 221 further comprises a characteristic storage module 222, a file management module 223, a data storage module 224, and a Bloom filter 225.

When the client 210 receives a new input file, the data chunking module 212 performs a data segmentation process on the input file. The data chunking module 212 may utilize fixed-size partition or content-defined chunking (CDC) to perform the data block segmentation process on the input file.

The fixed-size partition algorithm utilizes a pre-defined data block size to perform segmentation on the input file. The advantage of the fixed-size partition algorithm is simplicity and high-performance. The CDC algorithm is a variable-size partition algorithm, which divides the file into blocks of different sizes by using fingerprint data (for example, converting the file content into a preset hash value through a Rabin fingerprint algorithm).

Unlike the fixed-size partition algorithm, the CDC algorithm performs the data block segmentation process based on specific fingerprint data, and therefore the size of the data block is variable. The advantage of the CDC algorithm lies in that a strategy having flexible query or insertion of a data block is provided, so that the newly added data block can be placed in a destination rapidly.

After the data chunking module 212 accomplishes the data block segmentation, the data chunking module 212 outputs the generated data blocks to the fingerprinting module 213. The fingerprinting module 213 performs a characteristic processing procedure on the data blocks, and generates characteristic values corresponding to the data blocks. The fingerprinting module 213 may be implemented through, but is not limited to, an algorithm such as MD5, SHA-1, SHA-256, SHA-512, or One-way hash.

The characteristic value search module 214 compares the characteristic value of each data block with characteristic values stored in the client 210, so as to judge whether the same characteristic value exists. If the same characteristic value exists in the client 210, the data block corresponding to the compared characteristic values is deleted.

If the same characteristic value exists in the client 210, the characteristic value search module 214 sends a data block index request to the server 220 at the same time. The server 220 updates a number of a reference count in the data block, and returns a data block result to the client 210. If the same characteristic value does not exist in the client 210, the client 210 sends a query request to the server 220.

When the server data management module 221 receives the query request from the client data management module 211, the characteristic storage module 222 judges whether the characteristic value is recorded in the server 220 according to the query request.

First, the Bloom filter 225 receives the characteristic value of the data block from the client 210. The Bloom filter 225 judges whether the received data block is a modified data block, and outputs a judgment result to the characteristic storage module 222. If the characteristic value does not exist in the server 220, a corresponding data block is obtained from the client 210, and the new data block and the characteristic value are stored in the server 220. If the characteristic value exists in the server 220, the characteristic storage module 222 updates a number of a reference count in the data block, and returns a data block result. Moreover, a storage address of data blocks of each input file in the server 220 is recorded into an index file through the file management module 223, so as to manage location index information of all the data blocks of a target file in the index information and restore the target file. The data storage module 224 is used to store a meta-data of the data blocks and the input file.

In the present invention, the storage of all data blocks, the description of the meta-data, and the storage and management of a characteristic value are all implemented in the server 220, while the data segmentation of the input file and the calculation of the characteristic value are implemented by the client 210. Then, the information is exchanged between the server 220 and the client 210 through the network. When the client 210 processes data, the calculated characteristic value is sent to the server 220 first, if the data exists, only location reference information of the data block needs to be updated and the data block itself does not need to be transmitted over the network, and if the data does not exist, the data is sent to the server 220.

What is claimed is:

1. A processing system of data de-duplication, for performing a data de-duplication process on an input file through a server and a client, the system comprising:
a client data management module, being disposed in each client and receiving the input file, wherein the client data management module further comprises:
a data chunking module, for performing a data segmentation procedure on the input file and generating at least one data block;
a fingerprinting module, for performing a characteristic processing procedure on the data blocks and generating corresponding characteristic values; and
a characteristic value search module, for comparing the characteristic value of each data block with characteristic values stored in the client, wherein if the same characteristic value exists in the client, the data block corresponding to the compared characteristic values is deleted, and if the same characteristic value does not exist in the client, the client sends a query request to the server; and
a server data management module, connected to the client data management module through a network, wherein the server data management module further comprises:
a characteristic storage module, for judging whether the characteristic value is recorded in the server according to the query request, and if the characteristic value does not exist in the server, obtaining a corresponding data block from the client and storing the new data block and the characteristic value in the server;
a file management module, for recording a storage address of the data blocks of each input file in the server into an index file; and
a data storage module, for storing a meta-data of the data blocks and the input file.

2. The processing system of data de-duplication according to claim 1, wherein the data segmentation procedure comprises fixed-size partition, content-defined chunking (CDC), or sliding block chunking

3. The processing system of data de-duplication according to claim 1, wherein the characteristic processing procedure comprises MD5, SHA1, SHA256, or CRC32.

4. The processing system of data de-duplication according to claim 1, wherein if the same characteristic value exists in the client, the characteristic value search module sends a data block index request to the server, and the server updates a number of a reference count of the data block and returns a data block result, and the data block result comprises multiple successive characteristic values after the data block.

5. The processing system of data de-duplication according to claim 1, wherein the characteristic values of the client are stored in a memory or a buffer.

6. The processing system of data de-duplication according to claim 1, wherein if the characteristic value exists in the server, the characteristic storage module updates a number of a reference count of the data block and returns a data block result, and the data block result comprises multiple successive characteristic values after the data block.

7. The processing system of data de-duplication according to claim 1, further comprising a Bloom filter for receiving the characteristic value from the client, wherein the server judges whether the received data block is a modified data block through the Bloom filter, and outputs a judgment result to the characteristic storage module.
